(19) United States
(12) Patent Application Publication
(10) Pub. No.: US 2012/0077054 A1
(43) Pub. Date: Mar. 29, 2012

(54) ELECTROLYTIC GOLD OR GOLD PALLADIUM SURFACE FINISH APPLICATION IN CORELESS SUBSTRATE PROCESSING

(76) Inventors: Tao WU, Chandler, AZ (US); Charavanakumara Gurumurthy, Higley, AZ (US)

(21) Appl. No.: 12/890,661

(22) Filed: Sep. 25, 2010

(51) Int. Cl. B32B 15/01; C25D 1/00; B32B 15/04

(52) U.S. Cl. 428/600; 428/672; 428/670; 205/67

(57) ABSTRACT

Electronic assemblies including coreless substrates having a surface finish, and their manufacture, are described. One method includes electrolytically plating a first copper layer on a metal core in an opening in a patterned photoresist layer. A gold layer is electrolytically plated on the first copper layer in the opening. An electrolytically plated palladium layer is formed on the gold layer. A second copper layer is electrolytically plated on the palladium layer. After the electrolytically plating the second copper layer, the metal core and the first copper layer are removed, wherein a coreless substrate remains. Other embodiments are described and claimed.

### RELATED ART

Integrated circuits may be formed on semiconductor wafers made of materials such as silicon. The semiconductor wafers are processed to form various electronic devices. The wafers are diced into semiconductor chips (a chip is also known as a die), which may then be attached to a substrate using a variety of known methods. The substrate is typically designed to couple the die to a printed circuit board, socket, or other connection. The substrate may also perform one or more other functions, including, but not limited to, protecting, isolating, insulating, and/or thermally controlling the die. The substrate has conventionally been formed from a core made up of a laminated multilayer structure including woven glass layers impregnated with an epoxy resin material. Contact pads and conductive traces are formed on the structure to electrically couple the die to the device to which the package substrate is coupled. Coreless substrates have been developed to decrease the thickness of the substrate. In a coreless substrate, a removable core layer is typically provided, conductive and dielectric layers built up on the removable core, and then the core is removed.

A surface finish may be provided on the coreless substrate. The surface finish typically acts to protect the underlying substrate electrical connections until assembly. For example, if the substrate includes copper (Cu) connections, a surface finish may be placed over the copper. If a device is soldered to the substrate, the surface finish may interact with the solder. Alternatively the surface finish may be removed just prior to the soldering operation. Typical surface finishes for protecting copper include nickel/palladium/gold (Ni/Pd/Au) layers and organic solderability preservative (OSP). The nickel palladium gold surface finish includes a layer of nickel on the copper, followed by a layer of palladium on the nickel, followed by a layer of gold on the palladium. The nickel provides a barrier to copper migration and protects the copper surface from oxidation. The palladium acts as an oxidation barrier for the nickel layer. The gold layer acts to improve the wettability during formation of a solder joint. An OSP surface finish typically includes a water-based organic compound that selectively bonds with copper to form an organometallic layer that acts to protect the copper from oxidation.

When using lead free solders to couple the substrate to a structure such as a board, tin based solders including alloys of tin, silver, and copper (SAC) are commonly used. The surface finish is important to ensure a strong, durable joint. For example, if the surface finish inadequately protects the copper, then oxidation may occur, and the interactions between the oxidized copper and the lead free solder may result in the formation of an unsuitable joint. In addition, depending on the materials used in the surface finish, undesirable reactions may occur that deleteriously affect the properties of the joint.

### BRIEF DESCRIPTION OF THE DRAWINGS

Embodiments are described by way of example, with reference to the accompanying drawings, which are not drawn to scale, wherein:

FIGS. 1(A)-1(N) illustrate views of processing operations for forming a coreless substrate having a surface finish, in accordance with certain embodiments;

FIG. 2 illustrates a view of a coreless substrate having a surface finish, in accordance with certain embodiments;

FIG. 3 illustrates a flow chart of an assembly process for forming a coreless substrate having a surface finish, in accordance with certain embodiments;

FIG. 4 illustrates a flow chart of an assembly process for forming a coreless substrate having a surface finish, in accordance with certain embodiments;

FIGS. 5(A)-5(B) illustrate views of the formation of an assembly including a coreless substrate having a surface finish and a substrate to which the coreless substrate is joined, in accordance with certain embodiments;

FIG. 6 illustrates an electronic system arrangement in which embodiments may find application.

### DETAILED DESCRIPTION

As noted above, current solder joint formation between devices and substrates may be carried out using a lead free SAC solder and a substrate having a nickel palladium gold surface finish. One conventional method for forming the surface finish is using an electroless nickel/palladium-immersion gold process. In an electroless plating operation, no electrical current is provided. Metal ions are reduced by chemicals in plating solutions, and the desired metal is deposited on all surfaces.

Certain embodiments relate to processes in which certain layers are formed using an electrolytic plating process, which differs from an electroless plating process. First, an electrolytic plating process utilizes an electrical current passed through a solution contained dissolved metal ions, with the ions attracted to the charged metal surface to be deposited on. Second, the metal deposited using an electroless deposition method is typically amorphous in structure, whereas the electrolytically deposited metal is crystalline in structure. Certain embodiments utilize a method in which a temporary substrate core is electrically coupled to a power supply and then different surface finish metal layers are electrolytically deposited one after another.

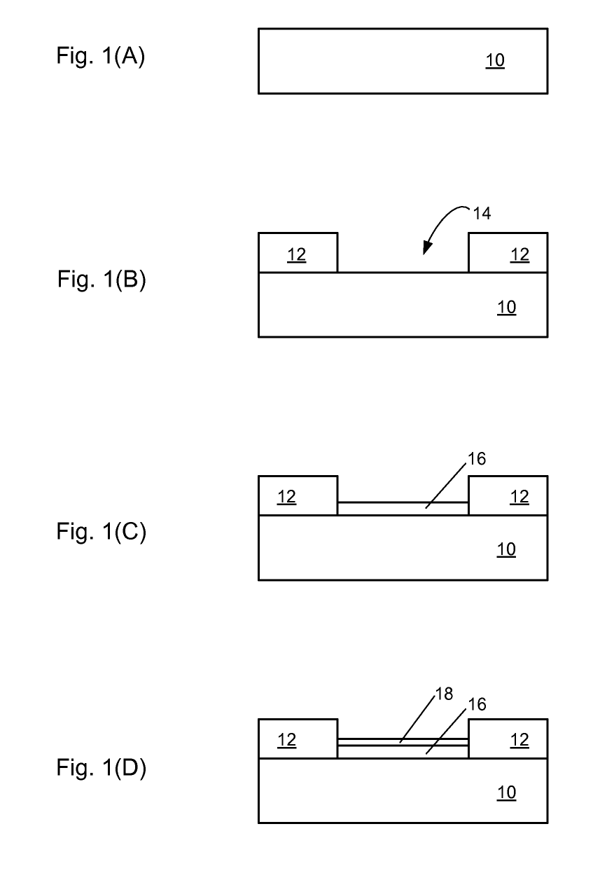

FIGS. 1(A)-1(N) illustrate operations in a method for forming a coreless substrate including surface finish layers including electrolytically deposited gold and palladium layers. As seen in FIG. 1(A), a temporary substrate core 10 is provided. The core 10 may be formed from, for example, a metal such as copper. FIG. 1(B) illustrates the formation of a patterned resist layer 12 having an opening 14 therein that exposes the core 10. A first copper layer 16 is electrolytically plated on the core 10, as illustrated in FIG. 1(C). A gold layer 18 is electrolytically plated onto the first copper layer 16, as illustrated in FIG. 1(D). A palladium layer 20 is electrolytically plated onto the gold layer 18, as illustrated in FIG. 1(E). Then a second copper layer 22 is electrolytically plated onto the palladium layer 20, as illustrated in FIG. 1(F). At this point of the manufacturing process, the gold layer 18 has a first surface in direct contact with the copper layer 16, and a second surface in direct contact with the palladium layer 20. The palladium layer 20 has a first surface in direct contact with the gold layer 18, and a second surface in direct contact with the second copper layer 22.

Next, as seen in FIG. 1(G), the patterned resist 12 is removed. A dielectric layer 24 is formed over the core 10 and electrolytically plated layers 16, 18, 20, 22, as illustrated in FIG. 1(H). The dielectric layer 24 may be formed using a build up process with a material such as, for example, a polymer. One example of a suitable material is a polymeric epoxy film known as Aginomoto Build-up Film (ABF), available from Ajinomoto Fine-Techno Company, Inc. A via 26 may be formed in the dielectric layer 24, to expose the second copper layer 22, as illustrated in FIG. 1(I). The via may be formed using any suitable technique, for example, layer drilling. The via 28 may be filled with a conductive material that will in turn be coupled to another conductive structure. One method to form the conductive material in the via 26 is to form a thin metal layer 28 as a seed layer on the surfaces defining the via 26, which includes the exposed portion of the second copper layer 22, and the dielectric layer 24, as illustrated in FIG. 1(J). Then a patterned photoresist layer may be formed on the thin metal layer 28 and define an opening that exposes the via region, as illustrated in FIG. 1(K). Next, as illustrated in FIG. 1(L), a metal may be electrolytically deposited into the via to form a layer 32, for example, copper. The photoresist layer 30 may then be removed, as illustrated in FIG. 1(M).

As illustrated in FIG. 1(N), the core 10 may then be removed, thus forming a coreless substrate 8. The first copper layer 16 may also be removed, which leaves a structure that includes a recess 36 defined in part by the surface finish gold layer 18. The recessed surface finish may be useful, for example, as a receiving space for another structure such as, for example, a contact pad or solder bump. As illustrated in FIG. 1(N), the surface finish includes gold layer 18 and palladium layer 20 above the gold layer 18. Electrically conducting layer 34 includes the second copper layer 22, the thin metal layer 28, and the metal layer 32.

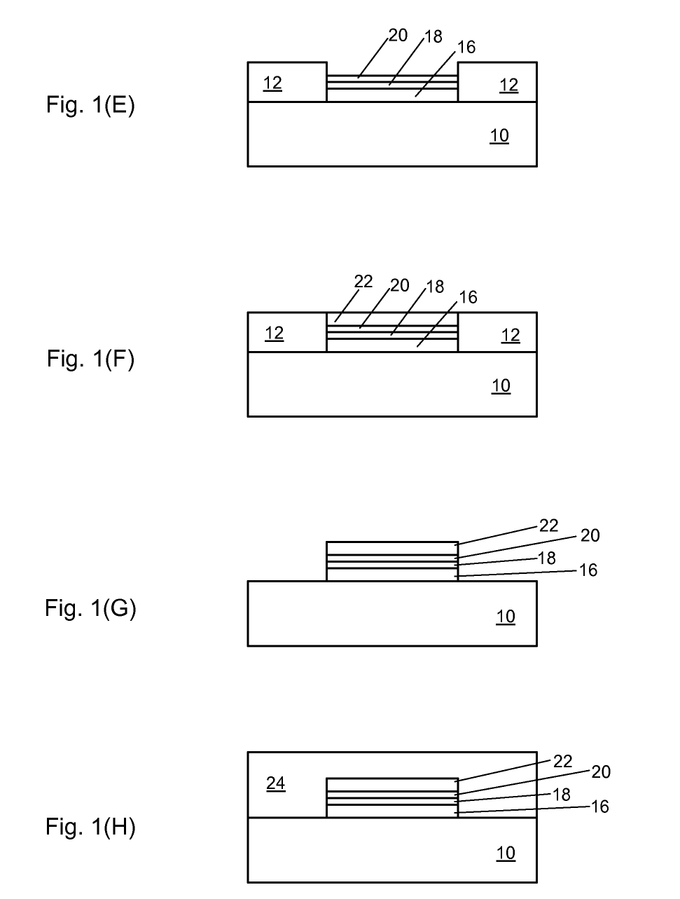

FIG. 2 illustrates another embodiment of a coreless substrate 108 that includes a surface finish layer 118 formed from electrolytically plated gold and positioned within a dielectric layer 124. The coreless substrate 108 also includes an electrically conducting layer 134. A recess 136 may also be present and can be used, for example, as a receiving location for connection to another structure. This embodiment may be formed using similar processes as described above for FIGS. 1(A)-1(N), except that there is no electrolytically plated palladium layer formed in the substrate.

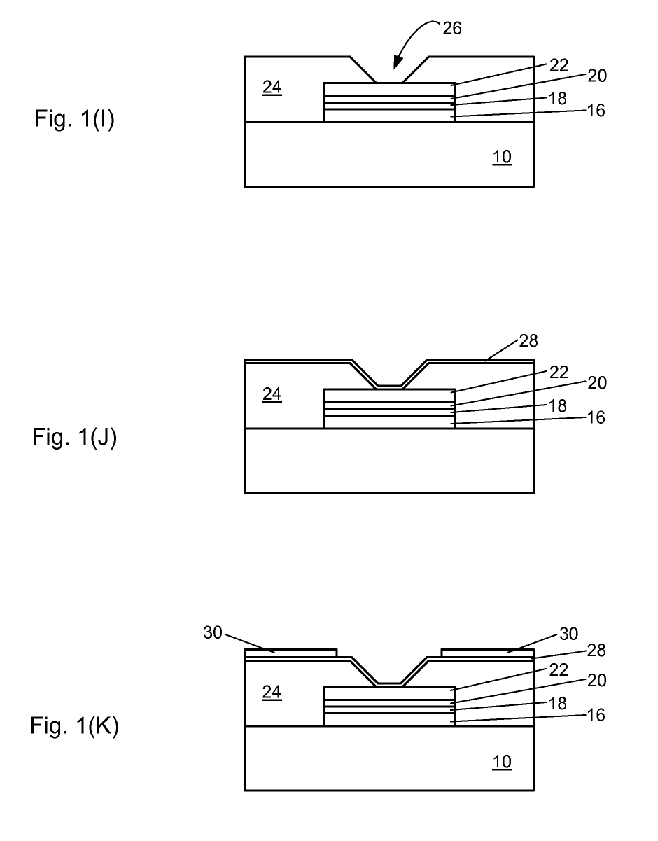

FIG. 3 illustrates a flowchart of operations for forming a coreless substrate including a surface finish that includes gold and palladium layers, in accordance with certain embodiments. Box 202 is providing a temporary core. The temporary core may be formed to comprise a metal such as, for example, copper. Box 204 is forming an electrolytically plated gold layer on the temporary core. The temporary core may be electrically coupled to a power supply to supply current for the electrolytic deposition. Box 206 is forming a palladium layer on the gold layer. Box 208 is forming a copper layer on the palladium layer. The palladium and copper layers may be formed using an electrolytic deposition process as described above. If a dielectric layer is formed and an opening formed to expose the palladium layer as described above in connection with FIGS. 1(H)-1(J), a thin metal layer may be formed on the dielectric layer surface (and on the exposed palladium layer) so that electrolytic deposition of the copper layer may be carried out. Box 210 is removing the temporary core using any suitable method, including, but not limited to, using an etching operation.

Box 212 is providing a lead free solder in contact with and/or adjacent to the surface finish present on the substrate after removal of the temporary core. The lead free solder may be in the form of a solder bump, with the layers oriented so that the Au and Pd layers are positioned between the lead free solder and the copper layer formed on the palladium layer. Box 214 is providing heat to reflow the solder and form a solder bond between the copper on the substrate and a structure on the other side of the lead free solder.

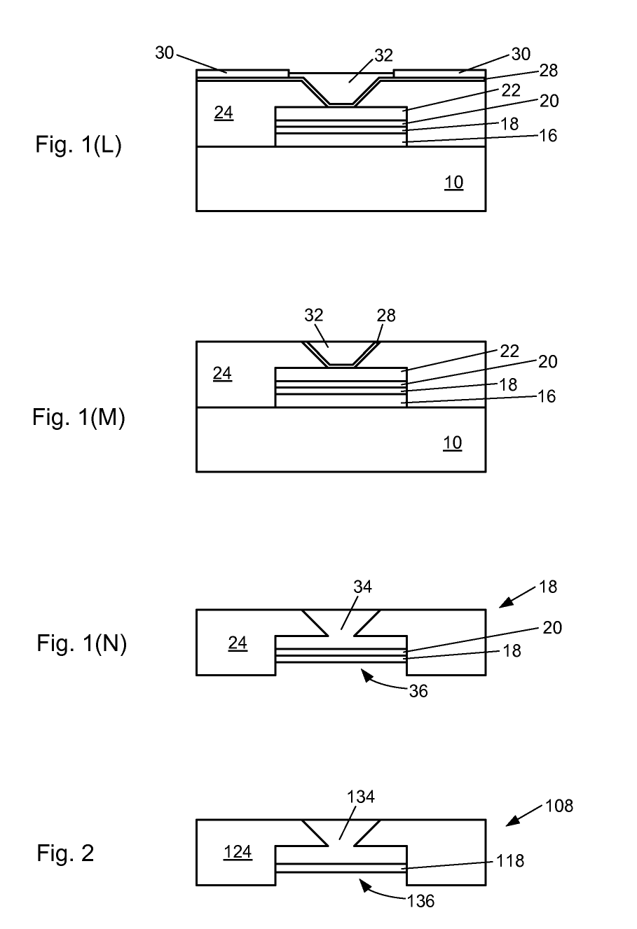

FIG. 4 illustrates a flowchart of operations for forming a coreless substrate surface finish that includes a gold layer, in accordance with certain embodiments. The operations are similar to those described above for FIG. 3, except that there is no palladium layer formed. Box 302 is providing a temporary core. The temporary core may comprise a metal such as, for example, copper. Box 304 is forming an electrolytically plated gold layer on the temporary core. Box 308 is forming a copper layer on the gold layer. The gold and copper layers may be formed using an electrolytic deposition process as described above. Box 310 is removing the temporary core using any suitable method, including, but not limited to, using an etching operation.

Box 312 is providing a lead free solder. The lead free solder may be in contact with and/or adjacent to the surface finish present on the substrate after removal of the temporary core. The lead free solder may be in the form of a solder bump, with the layers oriented so that the Au layer is positioned between the lead free solder and the copper layer. Box 314 is providing heat to reflow the solder and form a solder bond between the copper on the substrate and a structure on the other side of the lead free solder.

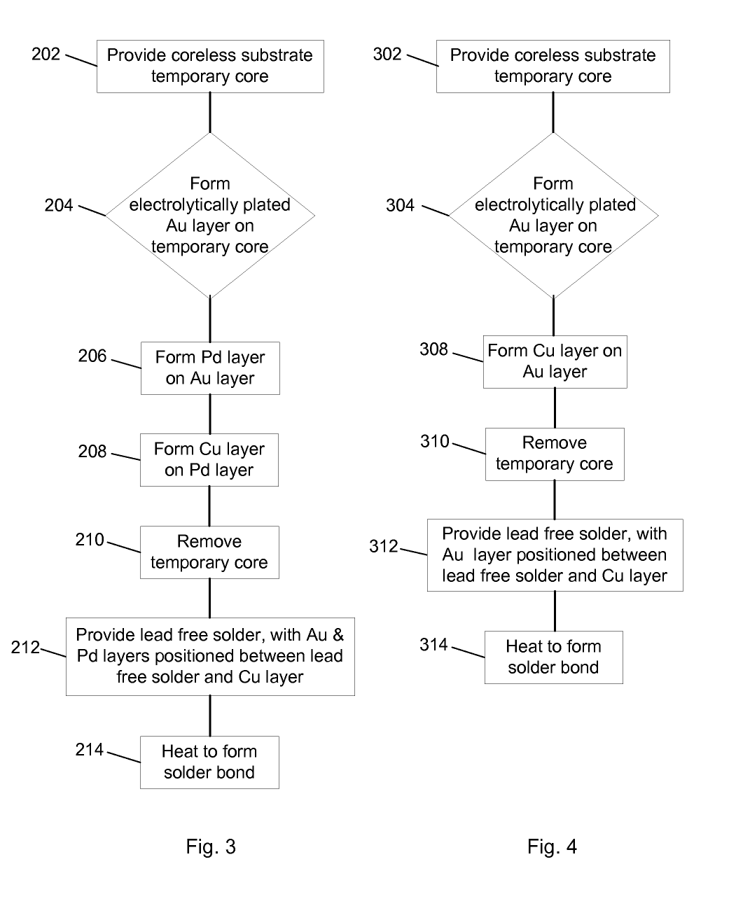

FIGS. 5(A)-5(B) illustrate a portion of an assembly in accordance with certain embodiments. FIG. 5(A) illustrates including coreless substrate 24 having a surface finish including gold layer 18 and palladium layer 20 positioned on copper layer 22. In this embodiment, the outer layer of the surface finish is the gold layer 18, and the inner layer of the surface finish is the palladium layer 20. A lead free solder bump 42 (for example, SAC) positioned on a bonding pad 44 on board 46 is positioned immediately adjacent to and in slight contact with the surface finish gold layer 18. FIG. 5(B) illustrates the assembly after a solder reflow process has been carried out to form a solder joint coupling the coreless substrate 24 to the board 46. An electrical connection is made through the solder bump 42 and the electrically conducting region 38 in the coreless substrate. The electrically conducting region 38 includes any portions of the gold layer 18 and palladium layer 20 that were not reacted during the reflow heating, as well as the underlying copper layer 22 and any other layers positioned above the copper layer 22. The area at and near the interface 40 of the conducting region 38 and the solder bump 42 may include reaction products from the reflow heating, which may include various alloys and intermetallics formed from, for example, various combinations of the copper layer 28, the tin, silver and copper in the SAC lead free solder, and the surface finish gold and palladium layers 18 and 20.

It has been found that the use of electrolytically deposited surface finishes including a gold layer alone or a gold layer and a palladium layer can effectively inhibit copper diffusion and minimize oxidation of copper through the gold surface. It is noted that the electrolytically deposited layers are crystalline and generally have a substantially greater density than electrolessly deposited layers. It has also been found that with electrolytically deposited gold or gold and palladium layers of a copper surface, high quality solder joint formation can be achieved between the copper and a lead free solder (SAC). It is believed that this is at least in part due to intermetallic compound formation between the copper and the tin in the SAC lead free solder.

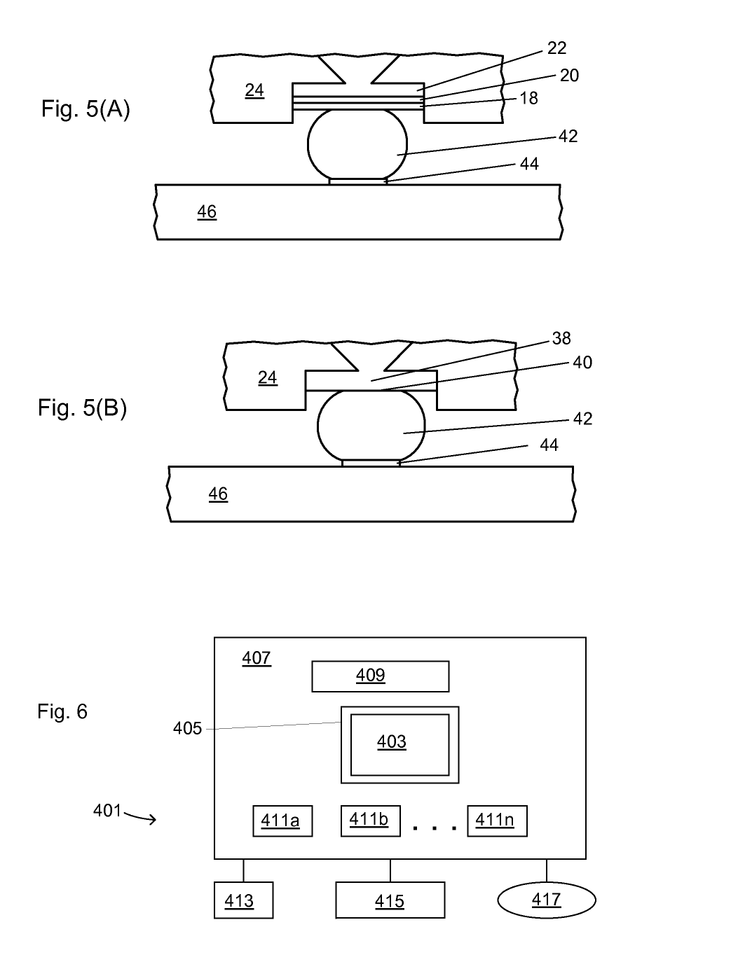

Assemblies including bodies such as substrates having surface finish layers as described in embodiments above may find application in a variety of electronic components. FIG. 6 schematically illustrates one example of an electronic system environment in which aspects of described embodiments may be embodied. Other embodiments need not include all of the features specified in FIG. 6, and may include alternative features not specified in FIG. 6.

The system 401 of FIG. 6 may include at least one central processing unit (CPU) 403. The CPU 403, also referred to as a microprocessor, may be a die which is attached to an integrated circuit package substrate 405, which is then coupled to a printed circuit board 407, which in this embodiment, may be a motherboard. The CPU 403 and package substrate 405 coupled to the board 407 is an example of an electronic device assembly that may be formed in accordance with embodiments such as described above. A variety of other system components, including, but not limited to memory and other components discussed below, may also include structures formed in accordance with the embodiments described above.

The system 401 may further include memory 409 and one or more controllers 411a, 411b . . . 411n, which are also disposed on the motherboard 407. The motherboard 407 may be a single layer or multi-layered board which has a plurality of conductive lines that provide communication between the circuits in the package 405 and other components mounted to the board 407. Alternatively, one or more of the CPU 403, memory 409 and controllers 411a, 411b . . . 411n may be disposed on other cards such as daughter cards or expansion cards. The CPU 403, memory 409 and controllers 411a, 411b . . . 411n may each be seated in individual sockets or may be connected directly to a printed circuit board. A display 415 may also be included.

Any suitable operating system and various applications execute on the CPU 403 and reside in the memory 409. The content residing in memory 409 may be cached in accordance with known caching techniques. Programs and data in memory 409 may be swapped into storage 413 as part of memory management operations. The system 401 may comprise any suitable computing device, including, but not limited to, a mainframe, server, personal computer, workstation, laptop, handheld computer, handheld gaming device, handheld entertainment device (for example, MP3 (moving picture experts group layer-3 audio) player), PDA (personal digital assistant) telephony device (wireless or wired), network appliance, virtualization device, storage controller, network controller, router, etc.

The controllers 411a, 411b . . . 411n may include one or more of a system controller, peripheral controller, memory controller, hub controller, I/O (input/output) bus controller, video controller, network controller, storage controller, communications controller, etc. For example, a storage controller can control the reading of data from and the writing of data to the storage 413 in accordance with a storage protocol layer. The storage protocol of the layer may be any of a number of known storage protocols. Data being written to or read from the storage 413 may be cached in accordance with known caching techniques. A network controller can include one or more protocol layers to send and receive network packets to and from remote devices over a network 417. The network 417 may comprise a Local Area Network (LAN), the Internet, a Wide Area Network (WAN), Storage Area Network (SAN), etc. Embodiments may be configured to transmit and receive data over a wireless network or connection. In certain embodiments, the network controller and various protocol layers may employ the Ethernet protocol over unshielded twisted pair cable, token ring protocol, Fibre Channel protocol, etc., or any other suitable network communication protocol.

The terms “a” and “an” as used herein denote the presence of at least one of the referenced item, and do not denote a limitation of quantity. In addition, terms such as “first”, “second”, and the like as used herein to not necessarily denote any particular order, quantity, or importance, but are used to distinguish one element from another.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art.

What is claimed:

1. A method comprising:
providing a metal core, the metal comprising copper;
forming a patterned photoresist layer on the metal core;
electrolytically plating a first copper layer on the metal core in an opening in the patterned photoresist layer;
electrolytically plating a gold layer on the first copper layer in the opening, so that the first copper layer is positioned between the metal core and the gold layer;
electrolytically plating a palladium layer on the gold layer, so that the gold layer is positioned between the first copper layer and the palladium layer;
electrolytically plating a second copper layer on the palladium layer;
wherein the gold layer includes a first surface in direct contact with the first copper layer and a second surface in direct contact with the palladium layer;
wherein the palladium layer includes a first surface in direct contact with the gold layer and a second surface in direct contact with the second copper layer; and
after the electrolytically plating the second copper layer, removing the metal core and the first copper layer, wherein a coreless substrate remains.

2. The method of claim 1, further comprising, after the electrolytically plating the second copper layer and prior to the removing the metal core:
removing the photoresist layer;
forming a dielectric material on the core and on the electrolytically plated layers;
forming a via in the dielectric material, the via positioned to expose a portion of the second copper layer;
forming a metal layer on the dielectric material and on the exposed portion of the second copper layer in the via;
forming a patterned photoresist layer on the metal layer, wherein the via is uncovered by the patterned photoresist layer;
electrolytically plating a third copper layer on the metal layer in the via; and
removing the patterned photoresist layer.

3. The method of claim 1, wherein there is no nickel layer formed in the coreless substrate.

4. The method of claim 1, wherein a surface of the coreless substrate includes a recess, and the outer surface finish layer of gold is positioned in the recess.

5. The method of claim 1, further comprising positioning a solder bump including lead free solder in contact with the gold layer, and providing heat to melt the solder and form a solder joint, the solder joint comprising an intermetallic compound including tin from the tin solder and copper from the second copper layer.

6. A method comprising:
providing a metal core, the metal comprising copper;
forming a patterned photoresist layer on the metal core;
electrolytically plating a first copper layer on the metal core in an opening in the patterned photoresist layer;
electrolytically plating a gold layer on the first copper layer in the opening, so that the first copper layer is positioned between the metal core and the gold layer;
electrolytically plating a second copper layer on the palladium layer;
wherein the gold layer includes a first surface in direct contact with the first copper layer and a second surface in direct contact with the second copper layer; and
after the electrolytically plating the second copper layer, removing the metal core and the first copper layer, wherein a coreless substrate remains.

7. The method of claim 6, further comprising, after the electrolytically plating the second copper layer and prior to the removing the metal core:
removing the photoresist layer;
forming a dielectric material on the core and on the electrolytically plated layers;
forming a via in the dielectric material, the via positioned to expose a portion of the second copper layer;
forming a metal layer on the dielectric material and on the exposed portion of the second copper layer in the via;
forming a patterned photoresist layer on the metal layer, wherein the via is uncovered by the patterned photoresist layer;
electrolytically plating a third copper layer on the metal layer in the via; and
removing the patterned photoresist layer.

8. The method of claim 6, wherein a surface of the coreless substrate includes a recess, and the outer surface finish layer of gold is positioned in the recess.

9. The method of claim 6, wherein the dielectric layer comprises ABF.

10. The method of claim 6, further comprising positioning a solder bump including lead free solder in contact with the gold layer, and providing heat to melt the solder and form a solder joint, the solder joint comprising an intermetallic compound including tin from the tin solder and copper from the second copper layer.

11. An assembly comprising:
a coreless substrate including a copper layer, a dielectric layer, and a surface finish on the copper layer;
the copper layer comprising a crystalline copper layer;
the surface finish comprising a crystalline gold layer;
wherein the crystalline gold layer is positioned to cover a surface of the copper layer.

12. The assembly of claim 11, wherein the surface finish further comprises a crystalline palladium layer, the crystalline palladium layer positioned between the crystalline gold layer and the crystalline copper layer.

13. The assembly of claim 11, wherein the crystalline gold layer and the crystalline copper layer are each formed using an electrolytic deposition process.

14. The assembly of claim 12, wherein the crystalline gold layer, the crystalline palladium layer, and the crystalline copper layer are each formed using an electrolytic deposition process.

15. The assembly of claim 11, wherein the coreless substrate includes a recess on a surface thereof, and wherein the surface finish is positioned in the recess.

16. The assembly of claim 12, wherein the coreless substrate includes a recess on a surface thereof, and wherein the surface finish is positioned in the recess.

17. The assembly of claim 11, wherein the coreless substrate includes no nickel layer therein.

18. The assembly of claim 12, wherein the coreless substrate includes no nickel layer therein.
